(19) United States
(12) Patent Application Publication
(10) Pub. No.: US 2020/0233409 A1
(43) Pub. Date: Jul. 23, 2020

(54) REMOTE PILOTING APPARATUS

(71) Applicant: Carmelo Scaini, Greely (CA)

(72) Inventor: Carmelo Scaini, Greely (CA)

(21) Appl. No.: 16/249,944

(22) Filed: Jan. 17, 2019

(51) Int. Cl. G05D 1/00; G05D 1/10; B64C 39/02; G06F 3/0338

(52) U.S. Cl. CPC G05D 1/0016; G05D 1/0033; B64C 2201/146; B64C 39/024; G06F 3/0338; G05D 1/101

(57) ABSTRACT

An apparatus for piloting a remote controlled vehicle comprising a frame for supporting a user, right and left hand mechanical controllers coupled to the frame, a position sensor and sensor conditioner to receive an electrical positioning signal from the position sensor, and a transmitter for transmitting a control signal to a remote controlled vehicle. The control system can remotely adjust at least one propulsion mechanism or control surface on the remote controlled vehicle for piloting the vehicle.

### FIELD OF THE INVENTION

The present invention pertains to an apparatus for remote piloting of vehicles, in particular suited to piloting of aircraft or aerial vehicles. In particular, the present apparatus can be used for remote piloting small aircraft or aerial vehicles with a mechanical controller.

### BACKGROUND

Handheld remote controlled (RC) devices are used as a means to control many remote technologies such as, for example, home electronics, gaming systems, toys, and drone aircraft to name a few. Handheld devices have been the operator's choice when dealing with small unmanned aircraft or remote controlled craft as they are lightweight and mobile. Recreational small remote controlled aircraft has had a steady following for commercial purposes such as surveying and in military operations, as well among hobbyists. With the advent of the information age, electronic hardware has undergone a renaissance through innovations in miniaturization for mobile cellphone technologies. Many advances in this area of technology have cross-pollinated into other industries such as medical robotics, manufacturing and unmanned aviation.

Small unmanned aircraft have steadily advanced in the level of performance and capability with the miniaturization of on board electronics and increase in data transfer speeds, with expanded applications span for both recreation and commercial uses. In the past few years, quad rotor drone technology has become the aerial platform of choice for aerodynamic autonomous flight research due to the simplicity and stability of the mechanical design. With no aerodynamic surfaces to deflect for aerodynamic control of flight, flight may be controlled with the use of 2-4 or more propellers driven by small brushless direct current (DC) motors.

Apparatuses for wireless control of a remote object are generally handheld and controlled by hand and/or finger and thumb movement. One general class of remote controllers has one or more buttons and joysticks and is manipulated with the hands. In an example, United States Patent Application US20090212968 to Willett describes a hand carried and operated remote control unit that has a handlebar with buttons.

Simplification of control devices has been an active area of drone research in autonomous flight, and many remote controlled toys and drones can be controlled using a handheld smartphone or tablet with appropriate control software and signal transmission capability. Many aerial remotely piloted vehicles are used to gather information and do not require a high level of speed or aggressive maneuvering during flight. For these vehicles the primary flight control can be accomplished onboard the aerial vehicle itself, while the secondary level of control (ie. guidance and/or go-to waypoint command) is provided via a remote control device and/or computer terminal. The remote (secondary) simplified level of control in these remote piloted vehicles is generally reduced to that of supervisory command level which is more suited to console workstations with keyboards and monitors.

Drone technology has grown in popularity in the past few years with the advent of drone racing as a sport. Coupled with first person view video technology and rapid visual data transfer from the remote vehicle to the pilot, drones fitted with a video camera are capable of wirelessly transmitting video real time to a remote operator fitted with video goggles giving a first person view and the visual sensation of flight. Drone racing has a significant following, however the primary means of remote control of the drones are handheld devices. With the expansion of competitive drone racing as a sport, where the competition is more about the piloting skills than the drone performance, the main drawbacks of handheld RC devices are the fact that pilots are limited to a single part of human anatomy, i.e. the hands or specifically the fingers and thumbs, to pilot a racing craft.

Flight simulators train operators on the use of controls of a real aircraft in a simulated environment. In a flight simulator, controls are positioned as they would be in a real aircraft to assist the learner in learning to pilot using real aircraft controls. In one example, a flight simulator of an aircraft would have a control wheel which is used to control pitch and roll attitude, and a flight simulator for a helicopter would have a collector arm to control lift and throttle of the main rotor in the helicopter. There remains a need for flight control options in an apparatus for controlling and remote piloting vehicles or aerial vehicles.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus and method for remote piloting a remote controlled vehicle.

In an aspect there is provided an apparatus for piloting a remote controlled vehicle comprising: a frame for supporting a user; a right hand controller movably coupled to the frame; a left hand controller movably coupled to the frame; at least one position sensor for sensing the position of the right hand controller and the left hand controller relative to the frame; a sensor conditioner to receive a positioning signal from the position sensor; and a transmitter for transmitting a control signal to the remote controlled vehicle; wherein differential positioning of the right hand controller and left hand controller controls the attitude of the aircraft.

In an embodiment of the apparatus, the right hand controller aerodynamic controls of the right side of the remote controlled vehicle and the left hand controller aerodynamic controls of the left side of the remote controlled vehicle.

In another embodiment of the apparatus, the positioning signal is an electrical positioning signal.

In another embodiment of the apparatus, the position sensors are mechanically coupled or optically coupled.

In another embodiment of the apparatus, the control signal remotely adjusts at least one propulsion device on the remote controlled vehicle.

In another embodiment of the apparatus, the control signal controls at least one control surface on the remote controlled vehicle.

In another embodiment of the apparatus, the mechanical controller is a variable controller.

In another embodiment of the apparatus, the frame comprises a seat or saddle.

In another embodiment, the apparatus further comprises at least one foot mechanical controller.

In another embodiment of the apparatus, the position sensor comprises at least one of a linear position transducer and a rotational position transducer.

In another embodiment of the apparatus, the frame is collapsible.

In another embodiment of the apparatus, the remote controlled vehicle is an aerial vehicle.

In another embodiment of the apparatus, the position sensors converts the displacement and the rate of change in displacement of the right hand controller and the left hand controller into the control signal.

In another aspect there is provided a method for piloting a remote controlled vehicle, the method comprising: mechanically displacing a mechanical hand controller coupled to a frame; measuring the mechanical displacement of the mechanical controller with a position sensor; converting the measured mechanical displacement into an positioning signal; conditioning the positioning signal into a control command signal; and transmitting the control command signal to a remote controlled vehicle; wherein the method is carried out by a user supported by the frame.

In an embodiment of the method, the position sensor measures an electrical voltage.

In another embodiment of the method, the remote controlled vehicle is an aerial vehicle.

In another embodiment of the method, the aerial vehicle is a quadrotor.

In another embodiment of the method, the control command signal controls a mechanical actuator to actuate at least one control surface on the remote controlled vehicle.

In another embodiment of the method, the control command signal controls an electrical motor to actuate at least one rotor on the remote controlled vehicle.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a perspective view of an embodiment of the apparatus comprising a frame and mechanical controllers;

FIG. 2A is a perspective view of an embodiment of the apparatus with a frame and controls;

FIG. 2B is a perspective view of an embodiment of the apparatus with a frame and controls;

FIG. 3 is an example flowchart of a method of how the thrust and attitude of an aerial vehicle can be controlled using the present apparatus;

FIG. 4 depicts an example interface control system on the apparatus and the aerial vehicle;

FIG. 5 is a schematic diagram of mechanical controllers and position sensors on a remote piloting apparatus;

FIG. 6 is a schematic diagram of an example quadcopter aerial vehicle and control system;

FIG. 7A is a perspective view of an embodiment of the apparatus with a frame and mechanical controllers;

FIG. 7B is a perspective view of an embodiment of the apparatus with a frame and mechanical controllers;

FIG. 8A is a perspective view of an embodiment of the apparatus with a frame and mechanical controllers;

FIG. 8B is a perspective view of an embodiment of the apparatus with a frame and mechanical controllers;

FIG. 9A is a perspective view of an embodiment of the apparatus with a frame and mechanical controllers;

FIG. 9B is a perspective view of an embodiment of the apparatus with a frame and mechanical controllers;

FIG. 10A is a close-up perspective view of an embodiment of the apparatus with a frame and hand controllers;

FIG. 10B is a close-up perspective view of an embodiment of the apparatus with a frame and hand controllers;

FIG. 11A is a perspective view of an apparatus frame configured to support a user in a lying position;

FIG. 11B is a perspective view of a user supported by a prostrate position frame;

FIG. 11C is a perspective view of a foldable apparatus frame;

FIG. 12 is an actuator design with integrated arms; and

FIG. 13 is an actuator design with independent arms.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

Herein is described an apparatus for remote piloting small aircraft or aerial vehicles having multiple control points which use multiple parts of the human body. The present apparatus unlocks the potential of piloting skills by a pilot flying a remote controlled aircraft or aerial vehicle by enabling control with more than just the hands, fingers, and/or thumbs to pilot the vehicle. In particular, the present remote piloting apparatus provides a structure and control system that enables use of additional limbs one would use in any other sport or activity, that are, the wrists, arms, legs and feet, to be used in controlling a remotely controlled vehicle.

In aircraft controllers where the aircraft is unmanned and controlled from a remote location and with demand for higher level automation, flight controllers can be designed that are not based on traditional configurations found in manned aircraft. In this way human workload in controlling complex aircraft can be taken into account and alternative controllers can be provided. A variety of control methods can be used to accommodate human factors and achieve a high level of control, and there is no necessity for control methods to correspond to actual flight controls as the controller is not being used to train someone for manned flight. In addition, advances in video streaming data transfer and in first person view technology have greatly improved the situational awareness of remote pilots and provide an opportunity for alternative and more human-centered aircraft and flight control configurations. As such, intuitive configurations of flight devices can be designed, for example having arm controls that respond in flight in a similar fashion as a bicycle would do when ridden, providing a familiarity with the control system and ease of human learning to pilot the remote apparatus.

The present apparatus addresses the limitations of handheld devices and systems that attempt to replicate actual control systems of manned vehicles by the introduction of a frame which is familiar to and accessible by the human body. Although the following description is focused on aerial vehicles and aircraft that can be remotely piloted using the present apparatus, it is noted that the apparatus can also be used to remotely pilot non-aerial vehicles, such as, for example, land vehicles such as cars, bicycles and motorcycles, water vehicles such as, for example, boats and submarines, and space vehicles.

Racing drones capable of high speeds can be controlled effectively with the mechanical controllers enabled by the apparatus, with the rate at which the controls are maneuvered adaptable to high vehicle travel speeds as well as to lower vehicle travel speeds. As the aerial vehicle speed increases, the piloting apparatus provides the pilot with an increased range of movement which allows a more natural control of the aerial vehicle. Accordingly, the range of motion of the pilot's body is more attuned to the movement of the aerial vehicle at higher speeds. Mechanical controllers such as arms, levers and pedals, among other mechanical controllers, can be proportioned on the apparatus frame to provide a larger range of displacement as compared to handheld controllers. Without being bound by theory, it is found that a larger range of displacement capability of the manual controls provides more control resolution in the operation of a remote vehicle, especially at high speeds. In one example, the altitude can be controlled by handheld lever arms and the speed can be controlled by foot pedals. This provides the pilot an expanded capability to control the remote vehicle at higher speeds as compared to the limited capability provided by limited range of motion finger or thumb operated devices. Drones can hover, and also fly at speeds of up to 80-120 mph. The control provided by the present apparatus enables stable flight over a broad range of aerial vehicle speeds and under a broad range of conditions and complex maneuvers.

First person view (FPV) technology has been an enabler of competitive drone racing as a sport. The present apparatus, when used in combination with FPV technology, provides the operator or pilot the sensation of manipulating the drone controls as if they were on board the flight without being bound by traditional mechanical and positional flight control configurations. This enhances the user race experience beyond that of visual to that of full body physical feel and/or strain similar to a sporting competition experience. Further, observing the piloting control of an RC aerial vehicle using the presently described apparatus can provide a more exhilarating experience for the pilot in the drone race and the audience watching the drone race and improve the acceptance of the sport of competitive drone racing to the next level of competition and skill. The present apparatus can further provide improved sensitivity control compared to that achievable using standard handheld RC devices by providing mechanical augmentation through wires, hydraulics, optical sensors, and/or springs to dampen and modulate operator inputs. In this way stability augmentation and high attunement of flight control can be further provided.

The present apparatus can have a variety of configurations. In one example of a remote piloting apparatus for a quadrotor drone aerial vehicle, the apparatus can have mechanical interface controllers for remotely piloting aerial vehicles which supports control of the vehicle via the presently described apparatus using the hand, arm, wrists and feet, as well as potentially other parts of the human anatomy.

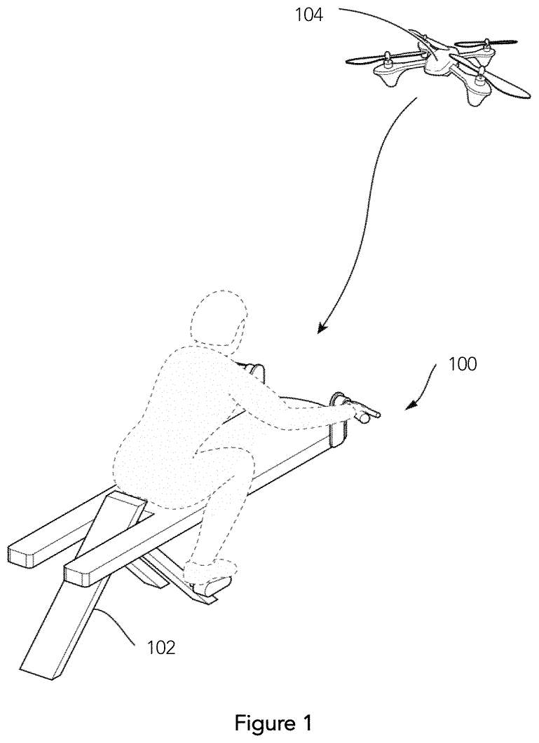

FIG. 1 illustrates an embodiment of the apparatus 100 comprising a frame 102 and mechanical controllers. The frame 102 supports the mechanical controllers, fixed positioning sensors, sensor conditioning electronics and at least one wireless transmitter, together referred to as control devices. The control devices are integrated onto a frame that enable a person to control an aerial vehicle 104 remotely. The apparatus can also comprise a seat or saddle to provide a place for the user to sit or recline comfortably and stably. In one preferable example, the frame resembles a bicycle, and the mechanical controllers for remote piloting the aerial device are similar to the control means that would be familiar to a human who knows how to ride a bicycle. For example, the mechanical controllers may include handlebars, brakes and/or shift levers, modulating lever-type pedals (similar to a car accelerator or car brake) and right and left hand controls. In other embodiments mechanical controllers can additional be provided in the form of handle and lever arms which can be joined to form a control wheel and/or joystick, yoke or other steering and/or mechanical control device. For additional dexterity, buttons and/or dials can be added to one or more of the handles, frame, and hand contollers for additional control by fingers and hands. Mechanical controllers may also include, for example, trim buttons on handles, which can be adjusted by the operator when the aircraft is not trimmed for stable flight. Other mechanical controllers on the frame can enable wireless control of a head-mounted display on the operator's FPV technology headset or display and can further control view, perspective, lighting, or flight features such as altimeter, speed, windspeed, etc. on a goggle or operator viewer display.

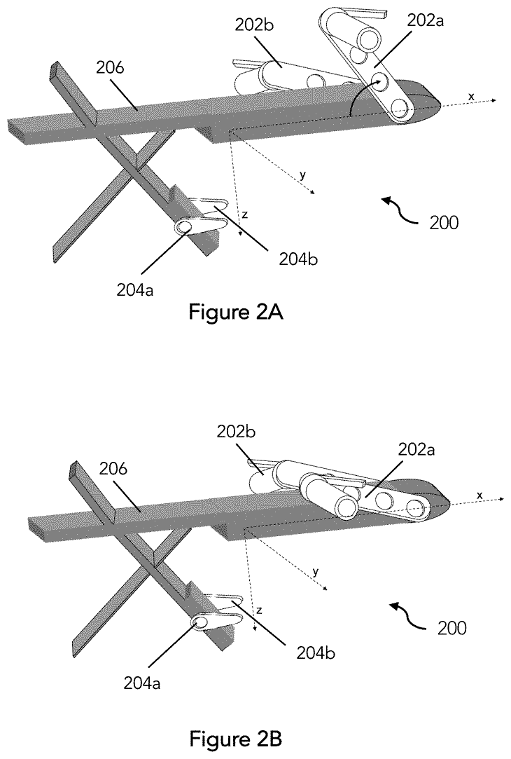

FIGS. 2A and 2B illustrate an embodiment of the apparatus 200 with frame 206. The configuration of the mechanical controllers including right hand controller 202a and left hand controller 202b and pedals 204a and 204b in communication with position sensors for each mechanical controller allows a pilot or operator to remotely adjust the aerial vehicle's thrust and/or control surface deflections to control the aerodynamic forces and moments exerted on the aerial vehicle by which controlled flight is achieved. The position sensor can be a linear position transducer or rotational position transducer to measure the linear and/or rotational displacement of each mechanical controller. Other configurations and/or additional features of the right hand controller and the left hand controller can comprise but are not limited to a handlebar, brake, shift lever, modulating lever-type pedal, handle lever, control wheel, joystick, yoke, button, dials, trim button, knob, handle, variable switch, steering wheel, accelerator pedal, yoke, control column, slider, track ball, centre stick or side-stick.

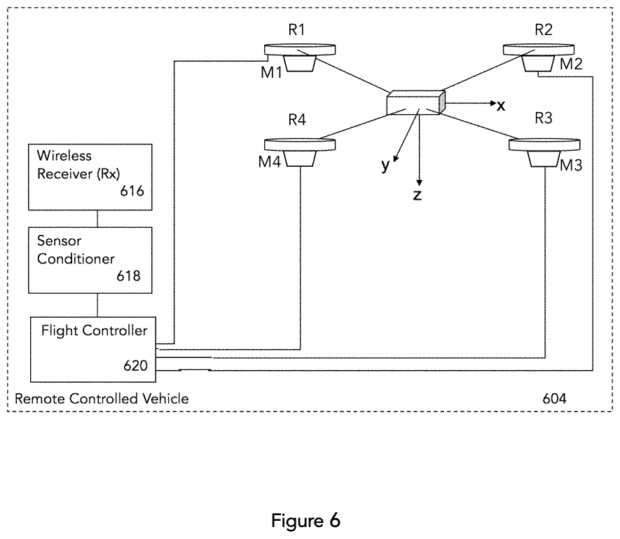

The aerodynamic forces and moments on an aerial vehicle are generated by its movement through the air. Although aerial vehicles can have a variety of configurations, the thrust of an aerial vehicle is the primary means that allows it to move through the air. The faster the vehicle moves through the air, the stronger these aerodynamic forces act on the vehicle. Aerodynamic forces and moments acting on the vehicle are affected by the vehicles attitude in pitch, roll and yaw about the x and y and z axes respectively (also shown on an example quadcopter aerial vehicle in FIG. 6). Thrust of the aircraft also has an effect on the lifting force that counters gravity acting on the aircraft. In FIG. 2A, the actuation of the right hand controller 202a actuated about the y-axis through the extension of the arm as shown by the arrow, remotely adjusts the rotational speed of the drone propeller rotors R4/R3 (shown in FIG. 6) which produce thrust. In the same fashion, lever arm left hand controller 202b actuated about the y-axis is used to adjust the rotational speed of the other two propeller rotors R2/R1 (shown in FIG. 6). As shown in FIG. 2B, a resting position of the right and left hand controllers 202a and 202b can provide a lower thrust, higher thrust, or a hovering (hold position) control signal to the motors controlling the drone rotors.

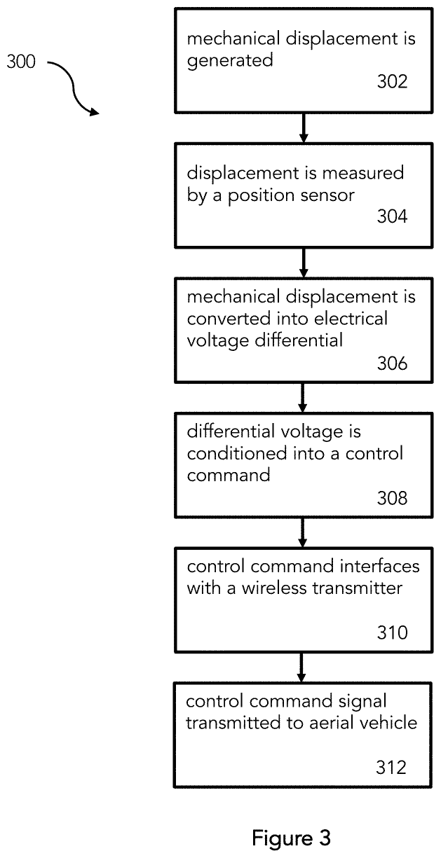

FIG. 3 demonstrates a method 300 of how the thrust and attitude of an aerial vehicle can be controlled using the present apparatus. Actuation of the mechanical controllers on the apparatus remotely adjusts the aerial vehicle's thrust and/or control surfaces. To accomplish this, a mechanical displacement is generated 302 on a mechanical controller of the apparatus. The positional displacement or differential positioning of each mechanical controller is measured by at least one position sensor 304, which serves as an input device to sense the positional displacement of the mechanical controller as effected by a user. The position sensor detects the relative position and rate of change of position of the mechanical controller and adjusts the internal resistance of a transducer to vary the voltage with respect to the mechanical displacement. The displacement of the mechanical controller is sensed by a position sensor, which is optionally a transducer which by adjusting its internal resistance in turn affects the magnitude of the electrical output voltage 306. The output voltage is then sent to a sensor conditioner to condition the signal to reduce noise and filter the signal to prepare the signal for wireless transmission and conditioned into a control command 308. The sensor conditioner can then scale the voltage of the signal received from the position sensor to condition the signal for wireless transmission. Signal conditioning can include amplification, filtering, converting, range matching, isolation and any other processes required to make sensor output suitable for processing after conditioning. The sensor conditioner can comprise electrical circuits, software control on a digital signal processing chip, or a combination thereof. In another embodiment, the position sensor is an optical sensor which translates visual information into positional displacement and can perform a similar positional detection of the mechanical controllers and convert the position into a signal for controlling the RC vehicle.

The control command then interfaces with a wireless transmitter 310 and the control command signal is transmitted to the aerial vehicle 312 for onboard processing at the aerial vehicle. The onboard processing of the control command signal will result in onboard actuation of thrust and/or control surface which in turn generates and/or acts on the aerodynamic forces present on the aerial vehicle to sustain a control of flight. The transmitter carrier frequencies can be modulated by analog or digital data stream, for example a pulse width modulated control signal is commonly used for the transmission of power level to electrical motors such as ones fitted on remote controlled aircraft. The wireless transmission system should be of a high bandwidth frequency that can accommodate a modulated signal that can cope with any transmission delay as to avoid lag associated with the remote operators commands and command response from the operated vehicle. Minimization of the control command/response time will reduce the potential for the aerial vehicle response to lag that of a piloted command. If this lag grows too large, the pilot may try to compensate by increasing or decreasing the command input before the intended effect, which may result in an oscillatory behaviour between the pilot and aircraft. This behaviour is commonly referred to as a pilot-induced-oscillation, or PIO.

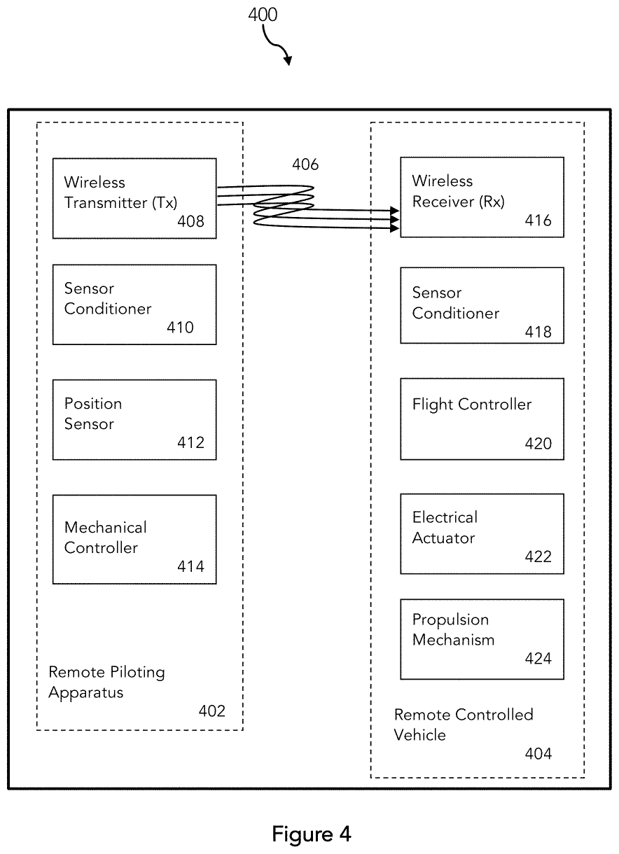

FIG. 4 depicts an example of an interface control system 400 on the remote piloting apparatus 402 and the remote controlled vehicle 404. Remote piloting apparatus 402 comprises a wireless transmitter (Tx) 408, a sensor conditioner 410, and at least one position sensor 412 in communication with a corresponding at least one mechanical controller 414. The at least one mechanical controller 414 is a device capable of movement input from a user and the corresponding position sensor senses the relative position of the mechanical controller and converts the displacement and the rate of change in displacement of the mechanical controller into a control signal. The mechanical controller can be, for example, a binary device to provide a binary control signal (on/off) to the position sensor, such as a button or toggle switch, track wheel or track ball. Alternatively, the mechanical controller can be a variable mechanical controller such that it provides a range of spatial configurations to the position sensor. Non-limiting examples of variable mechanical controllers for the right and left hand controllers include a knob, joystick, handle, variable switch, steering wheel, lever arm, accelerator pedal, yoke, button, track ball, or slider. In one example, variable thrust can be applied by receiving a control signal from a control yoke (also known as a control column), centre stick or side-stick similar to that found in aircraft control systems.

The control signal 406 sent by the wireless transmitter 408 can be a radio signal, which may be tunable and/or manually adjustable. Additional transmission frequencies of the control signal 406 enables multiple remote controlled vehicles to be flown at the same time with each being controlled by a single remote piloting apparatus. A channel selector can allow a user to select a channel on which the transmitter 408 operates. Each channel used within the vehicle remote control system can include a different remote control signal so that it controls only one vehicle 404. Control circuitry converts the user generated commands from user inputs into a control signal 406 which includes the remote control operations to be performed by the remote controlled vehicle. Once the control circuitry converts the user inputs into the control signal 406 for the selected wireless channel, the control signal is modulated and then sent to a remote control transmission link or transmitter 408, which can be an antenna designed for signals, for example radio frequency signals. Other wireless transmission systems can be used including but not limited to bluetooth, wi-fi, optical or laser pulsing, or other electromagnetic signal transmission.

As shown in FIG. 4, the control signal 406 sent to the remote controlled vehicle is used to control the motor(s) speed and attitude of the vehicle 404. A wireless receiver (Rx) 416 comprises an antenna to receive the control signal 406 and provides the control signal to a flight controller 420. In aerial vehicles, the control signal 406 controls the pitch, yaw, roll and motor(s) speed/thrust of the remote controlled vehicle by input received by the mechanical controller 414 on the remote piloting apparatus 402. The flight controller 420 takes an input and outputs a voltage to each motor depending on the control signal. The flight controller 420 provides a signal to one or more electrical actuator 422 which provides a voltage to at least one propulsion mechanism 424 to propel the remote controlled vehicle 404. The propulsion mechanism 424 on the remote controlled vehicle 404 can be comprised one or more motors which have a range in voltage/threshold attached to rotors, or any type of thrust or control surface and controlled by the method as described to create a vehicle capable of flight, sail and/or drive over sea or land. The sensor conditioner 418 on the remote controlled vehicle 404 conditions signal received by the wireless receiver to flight controller. The flight controller controls speed of the propulsion mechanism 422 electrically or using a board or chip with microprocessor, such as, for example, a field-programmable gate array (FPGA) chip.

The flight controller 420 can also control mechanical actuators on a remote controlled vehicle. Mechanical actuators can be, for example, rotational or linear actuators, and take an electrical input from the flight controller to create a mechanical displacement. Some examples of mechanical actuators on the remote controlled vehicle can include but are not limited to a gas canister, still camera, video camera, parachute, payload release, payload activation and aerodynamic control surface actuators. Control surfaces can be controlled by mechanical actuators on an aerial remote controlled vehicle and can be anywhere on the aircraft body, such as on wings, fuselage and tail, and manipulate airflow over the aerial vehicle to counter an aerodynamic force or moment. The main control surfaces of a fixed-wing aircraft are attached to the airframe on hinges or tracks so they may move and thus deflect the air stream passing over them. This redirection of the air stream generates an unbalanced force to rotate the plane about the associated axis. The control surfaces can be changed automatically based on pre-programmed inputs into the flight controller and/or can be controlled by the mechanical controllers 414 on the remote piloting apparatus. Other sensor inputs on the remote controlled vehicle including but not limited to altitude, pressure, air speed, attitude, can be sent to the FPV goggles of the pilot or operator, a display screen, and/or to the remote piloting apparatus 402 for visual and/or other feedback to the apparatus frame and/or the mechanical controllers. Dampening or haptic feedback of the mechanical controllers can also provide feedback to the pilot on data obtained by the remote vehicle for further information or enhanced experience during piloting. Other feedback provided can be audio, visual, haptic, vibrational, temperature, frame angle, or any other sensory feedback.

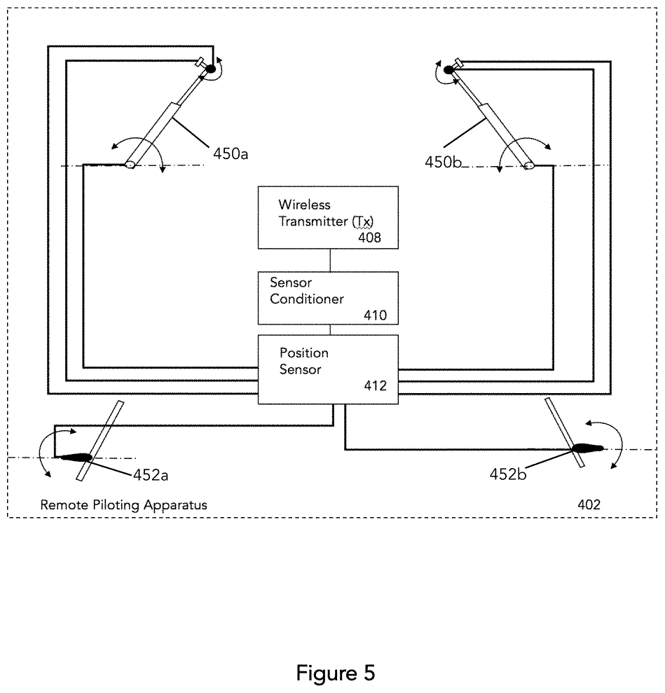

The force applied to the mechanical controller as measured by the position sensor is converted into an electronic signal to control the remote controlled vehicle 404. This is further shown in FIG. 5 which shows mechanical controllers 450a, 450b, 452a and 452b connected to a position sensor 412 hub. The position sensor voltage, Vₛ₁, can be described as follows:

Vₛ₁=c*Theta_{A} Equation 1.0

where, c=coefficient of displacement and
Theta_{A}=rotational displacement;
(Note: Theta_{A} can be replaced by Delta_{A} for linear potentiometers where, Delta_{A}=linear displacement)

The sensor conditioner voltage, Vₛ₂, can be described as follows:

Vₛ₂=c*Vₛ₁=(% Throttle) Equation 2.0

where, c=factor coefficient and

Vₛ₁=positioning sensor voltage.

The rotational speed (angular velocity), w, of the rotors on the aerial vehicle can be described as follows:

w=(% Throttle)*cr+b Equation 3.0

where, cr=% throttle to angular velocity coefficient and
b=linear interpolation constant.

The motor thrust of the aerial vehicle motors T can be described as follows:

T=cT*rho*Ar*r²*w² Equation 4.0

where, cT=thrust coefficient
rho=air density
Ar=cross sectional area of propeller rotation
r=rotor propeller radius, and
w=angular velocity of rotor

FIG. 5 is a schematic diagram of the position sensors on the remote piloting apparatus 402. As shown in FIG. 5, mechanical controllers 450a and 450b (also referred to as the right hand controller and left hand controller) are manipulated by the hands or arms of an operator and the position signal is sent to one or more position sensor 412. Similarly, the position of foot mechanical controllers 452a and 452b is detected by one or more position sensor 412. The position sensors send the position signal to signal conditioner 410 which is then conveyed to wireless transmitter 408 for transmitting to the remote controlled vehicle. The connection between each mechanical controller and its associated position sensor can be electrical or mechanical. In an example, mechanical controller 450a can have a rotating lever arm which communicates rotational movement to its associated fixed position sensor.

FIG. 6 is a schematic diagram of a quadcopter remote controlled vehicle 604 and control system. The quadcopter has four rotors R1, R2, R3 and R4, each connected to a motor, labeled motors M1, M2, M3, and M4. Wireless receiver (Rx) 616 receives a control signal from a wireless transmitter on a remote piloting apparatus and send the signal to a sensor conditioner 618. The flight controller 620 then sends a voltage signal to each of the motors to control the speed of each of the rotors, respectively. As described above, the speed of each of the rotors in relation to the other motors controls the pitch, yaw, roll and speed of the aerial quadcopter.

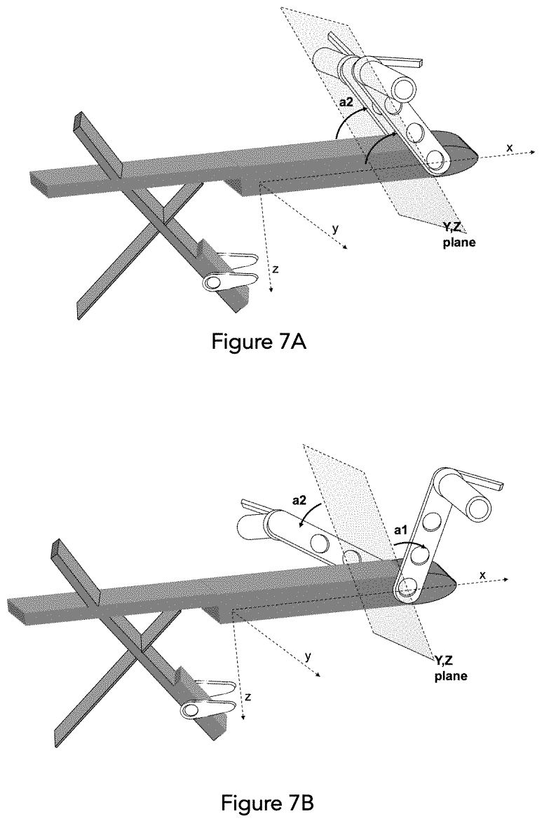

FIG. 7A is a perspective view of an embodiment of the apparatus with a frame and mechanical controllers. As shown, actuating both right hand controller a1 and left hand controller a2 about the y-axis increases the rotational speed of all 4 rotors R1, R2, R3 and R4 (shown in FIG. 6) which produce thrust that lifts the drone off of the ground to a hovering position. This is the result of individual activation of lever arm a2 actuated about the y-axis to adjust the rotational speed of rotors R1/R2 together with activation of lever arm a1 actuated about the y-axis to adjust the rotational speed of rotors R3/R4, as depicted in FIG. 6. FIG. 7B is a perspective view of an embodiment of the apparatus with a frame and mechanical controllers. Actuation of both right hand controller a1 and left hand controller a2 both actuated about the y-axis but in the opposite direction of motion through the extension of one arm (the human arm) and the retraction of the alternate arm (the human arm) will produce a thrust displacement between the two pairs of rotors, the R3/R4 pair and R2/R1 pair, resulting in a rolling moment about the x body axis of the drone aerial vehicle as shown in FIG. 6.

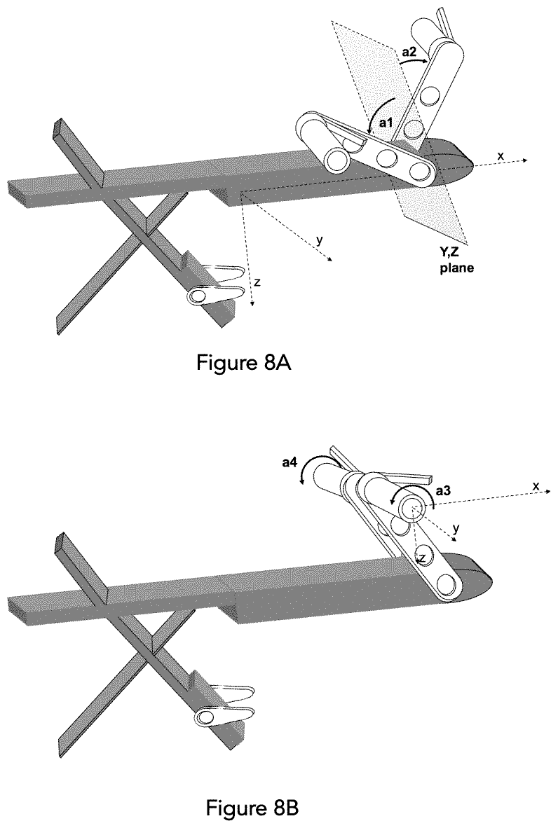

FIG. 8A is a perspective view of an embodiment of the apparatus with a frame and mechanical controllers. Actuation of both lever arms right hand controller a1 and left hand controller a2 both actuated about the y-axis but in the opposite direction of motion through the extension of one arm (the human arm) and the retraction of the alternate arm (the human arm) will produce a thrust displacement between the two pairs of rotors, the R3/R4 pair and R2/R1 pair, results in a rolling moment about the x body axis of the drone aerial vehicle, as shown in FIG. 6.

FIG. 8B is a perspective view of an embodiment of the apparatus with a frame and mechanical controllers. As shown, both right and left mechanical controller lever arms are actuated, which provides a control signal to increase the rotational speed of all 4 rotors on a quadcopter aerial vehicle, which produces thrust that lifts the drone off of the ground to a hovering position. Handles a3 and a4 are affixed to lever arms to provide a rotational actuation by a rotation of the wrist. This can be used, for example, to affect the yaw attitude of an aerial vehicle. Correlating the rotational displacement of the handles a3 and a4 about their axes to the speed of the aerial drone rotors R2/R4 and R3/R1 respectively, as shown in FIG. 6. In this embodiment, handle a3 actuation correlates to the speed of rotors R2/R4 and handle a4 correlates to the speed of rotors R3/R1. A variation of rotor speed between two pairs of motors R2/R4 and R3/R1 will result in a yawing moment about the aerial vehicle z-body axis.

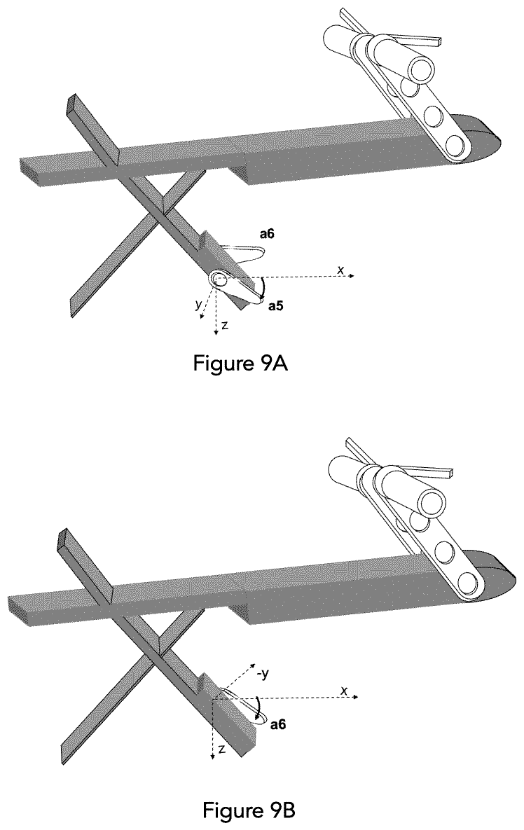

FIG. 9A is a perspective view of an embodiment of the apparatus with a frame and mechanical controllers. Pedals attached to the frame are intended to provide two separate functions. The pedal a5 actuated about the y-axis acts as a mechanical controller to controls the rotational speed of rotor pairing R4/R1 where an increase in rotational speed of this pairing would result in a thrust displacement with the R3/R2 rotors, as shown in FIG. 6. This thrust displacement creates a rolling moment about the body y-axis of the aerial drone causes an effect of the vehicle pitch about the y-axis.

FIG. 9B is a perspective view of an embodiment of the apparatus with a frame and mechanical controllers. The pedal a6 is a mechanical controller that can be used for a multitude of control functions including, for example, in controlling higher levels of control such as flight path angle, or can be used for situational awareness controls such as activation of a rear mounted camera on the aerial vehicle.

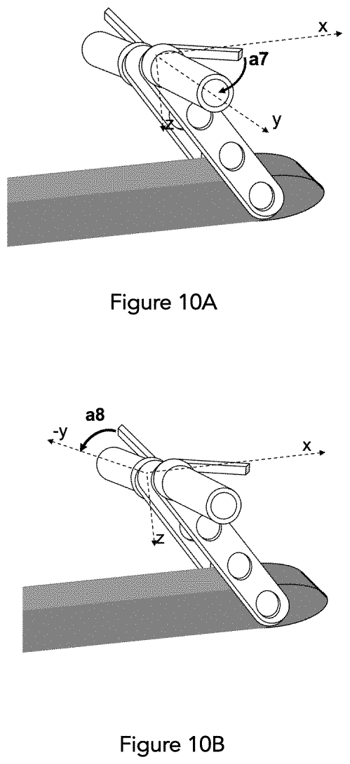

FIG. 10A is a close-up perspective view of an embodiment of the apparatus with a frame and hand controllers. Hand levers affixed to each handle provide separate functions as well. Similar to the peddle control a5, handle lever a7 actuated along the X-Y plane controls the rotational speed of rotors R3/R2 where an increase in rotational speed of this pairing would result in a thrust displacement with the R4/R1 rotors.

FIG. 10B is a close-up perspective view of an embodiment of the apparatus with a frame and hand controllers. Handle lever a8 actuated along the X-Y plane is a generic mechanical controller that can be used for a multitude of control functions including, for example, controlling higher levels of control such as flight path angle. Handle lever a8 can also be used for situational awareness controls such as activation of a rear mounted camera on an aerial vehicle. In the context of drone racing, a combination of hand lever a8 and foot pedal a6 can be used to upshift and downshift the drone aerial vehicle interconnected on-board battery by supplying battery power to the rotors which increase or decrease thrust power as required.

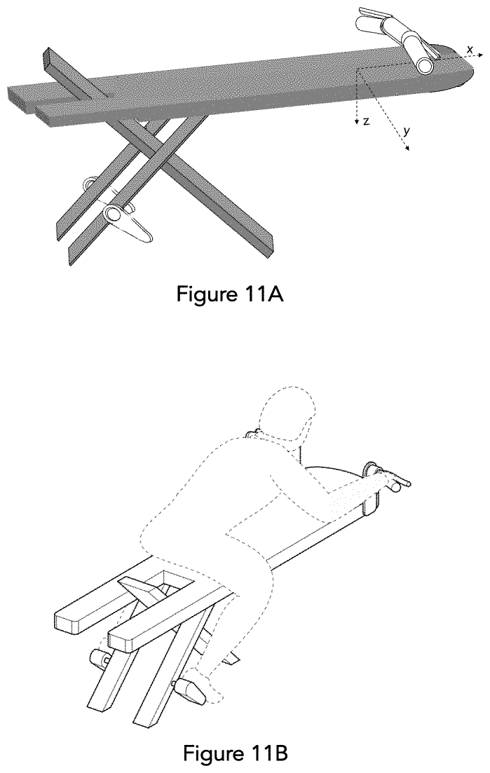

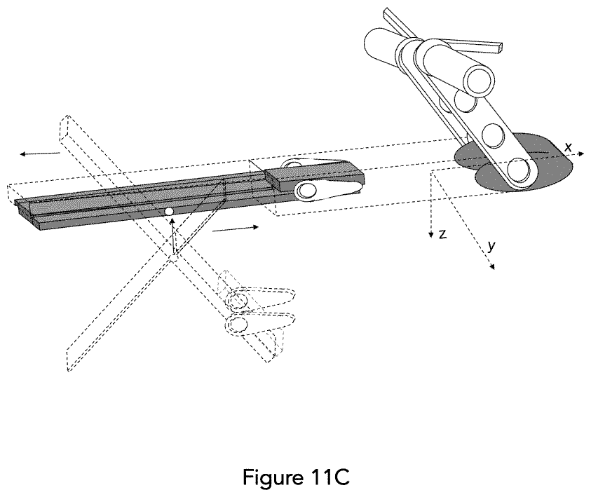

Alternative configurations of the presently described remote piloting apparatus can be envisaged such as a frame to position an operator in a seated, standing and/or lying position or prostrate position. FIG. 11A is a perspective view of an apparatus frame configured to support a user in a lying position. The apparatus frame can be modified to suit an operator in a seated, standing or a lying position wherein the mechanical controls can be reconfigured to accommodate these variations. In this example of a lying configuration, the mechanical controller lever arms are shortened and combined to form a control wheel that rotates about the X-Y plane, and the foot pedal controls are re-positioned to the back bracing legs of the foldable stand.

FIG. 11B is a perspective view of a user supported by a prostrate position frame. The apparatus frame can further be provided and the mechanical actuators can be reconfigured to accommodate these variations. As shown in FIG. 11C, mobility of the control device can be provided by having a collapsible, foldable frame that folds during transport or storage. The frame can also optionally comprise a base, or attachment features to attach the frame to a base in a static or movable arrangement to provide additional support for the frame.

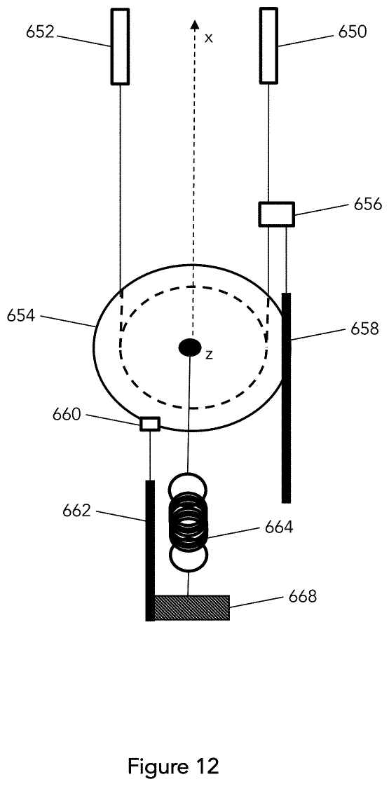

FIG. 12 illustrates an example of an electrical control system for two lever arms which can serve as right and left hand controllers, and two independent position sensors, where one of the position sensors is used to command pitch attitude and the second position sensor commands roll attitude based on the position differential of the arms as controlled by the pilot. As shown, first lever arm 650 and second lever arm 652, corresponding to right and left hand controllers, are connected to a castor wheel 654 to measure relative position and/or displacement of the lever arms using a first coupler 656 at a first position sensor 658. Rotation of the castor wheel 654 about the z-axis provides a position or displacement indication of the lever arms, which is measured by first position sensor 658. A second coupler 660 and second position sensor 662 measures position/displacement of the first and second lever arms 650, 652 through spring 664 which is anchored to the frame 668.

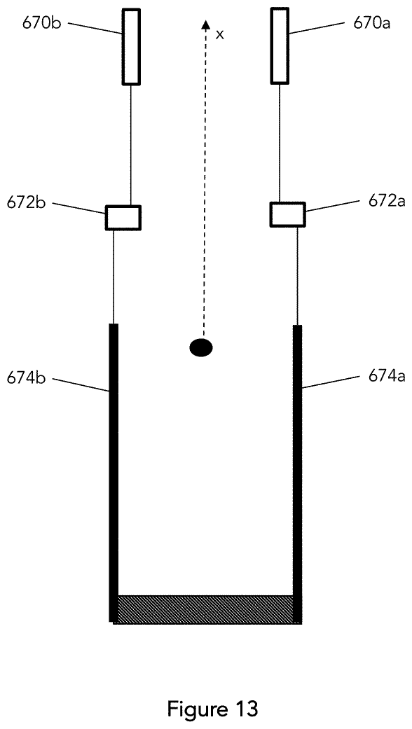

FIG. 13 illustrates an example of an electrical control system for two lever arms 670a and 670b which can serve as right and left hand controllers, each with its own independent position sensors 674a and 674b. Couplers 672a and 672b couple lever arms 670a and 670b with position sensors 674a and 674b to provide a calculated position differential between the sensed position. The calculated differential can then convert the position or displacement to provide the commanded pitch and roll attitude for the vehicle and can be done in the sensor conditioner, flight controller, or a combination thereof. In an alternative to an electrical position sensing system, the position sensors can be optical sensors for detecting the position of each of the control arms.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

1. An apparatus for piloting a remote controlled vehicle comprising:
a frame for supporting a user;
a right hand controller movably coupled to the frame;
a left hand controller movably coupled to the frame;
at least one position sensor for sensing the position of the right hand controller and the left hand controller relative to the frame;
a sensor conditioner to receive a positioning signal from the position sensor; and
a transmitter for transmitting a control signal to the remote controlled vehicle;
wherein differential positioning of the right hand controller and left hand controller controls the attitude of the aircraft.

2. The apparatus of claim 1, wherein the right hand controller aerodynamic controls of the right side of the remote controlled vehicle and the left hand controller aerodynamic controls of the left side of the remote controlled vehicle.

3. The apparatus of claim 1, wherein the positioning signal is an electrical positioning signal.

4. The apparatus of claim 1, wherein the position sensors are mechanically coupled or optically coupled.

5. The apparatus of claim 1, wherein the control signal remotely adjusts at least one propulsion device on the remote controlled vehicle.

6. The apparatus of claim 1, wherein the control signal controls at least one control surface on the remote controlled vehicle.

7. The apparatus of claim 1, wherein the mechanical controller is a variable controller.

8. The apparatus of claim 1, wherein the frame comprises a seat or saddle.

9. The apparatus of claim 1, further comprising at least one foot mechanical controller.

10. The apparatus of claim 1, wherein the position sensor comprises at least one of a linear position transducer and a rotational position transducer.

11. The apparatus of claim 1, wherein the frame is collapsible.

12. The apparatus of claim 1, wherein the remote controlled vehicle is an aerial vehicle.

13. The apparatus of claim 1, wherein the position sensors converts the displacement and the rate of change in displacement of the right hand controller and the left hand controller into the control signal.

14. A method for piloting a remote controlled vehicle, the method comprising:
mechanically displacing a mechanical hand controller coupled to a frame;
measuring the mechanical displacement of the mechanical controller with a position sensor;
converting the measured mechanical displacement into an positioning signal;
conditioning the positioning signal into a control command signal; and
transmitting the control command signal to a remote controlled vehicle;
wherein the method is carried out by a user supported by the frame.

15. The method of claim 14, wherein the position sensor measures an electrical voltage.

16. The method of claim 14, wherein the remote controlled vehicle is an aerial vehicle.

17. The method of claim 14, wherein the aerial vehicle is a quadrotor.

18. The method of claim 14, wherein the control command signal controls a mechanical actuator to actuate at least one control surface on the remote controlled vehicle.

19. The method of claim 14, wherein the control command signal controls an electrical motor to actuate at least one rotor on the remote controlled vehicle.
